(19) United States
(12) Patent Application Publication
(10) Pub. No.: US 2006/0020594 A1
(43) Pub. Date: Jan. 26, 2006

(54) Hierarchical drift detection of data sets

(75) Inventors: Neeraj Garg, Redmond, WA (US); Michael T. Daly, Redmond, WA (US); Mahesh Jayaram, Bellevue, WA (US); Indrojit N. Deb, Redmond, WA (US); Kulothungan Rajasekaran, Andhra Pradesh (IN)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/896,619

(22) Filed: Jul. 21, 2004

(51) Int. Cl. G06F 17/30

(52) U.S. Cl. 707/6

(57) ABSTRACT

The present leverages data hierarchies to provide a systematic means to determine data differences between equivalent data. This allows disparate data storage systems to efficiently determine divergent data locations by utilizing, for example, data signatures representative of varying degrees of data granularity. Comparative analysis can then be performed between the databases by employing an iterative approach until the desired level of data granularity is obtained. This allows, in one instance of the present invention, discrepant data to be determined without the transfer of large amounts of data and without requiring homogeneous data storage systems. Another instance of the present invention utilizes equivalent logical data views from non-identical data sets to determine data discrepancies. Yet another instance of the present invention determines discrepancies of a federated and/or integrated data system by employing reversible data statistical signatures, providing a simplistic transfer protocol and sheltering each data system from the other's complexities.

### TECHNICAL FIELD

The present invention relates generally to data synchronization, and more particularly to systems and methods for determining discrepancies between data sets.

### BACKGROUND OF THE INVENTION

The proliferation of digital information has created vast amounts of digital data. Digitized information such as, for example, sales records and customer databases, allow businesses to quickly access their information to increase their profitability and customer satisfaction. However, storing all of this information digitally frequently causes databases to reach terabyte levels in size. Large databases are beneficial when storing data but often become extremely problematic when attempting to manipulate the database, due to its sheer size. This becomes apparent when businesses who share common data attempt to store duplicate information at separate locations or when two different businesses try to work together and correlate their databases. For example, in a merger, two companies will try to correlate records for the same consumer in both company's databases. However, they may not be able to merge the two systems, so they must be kept in synchronization by propagating updates.

Over time, due to added and/or deleted information and other changes, the two different databases will “drift” or grow apart from each other. When this occurs, the databases are no longer identical and must be “synchronized” to ensure that the two databases remain the same.

One method of synchronizing the information is for a business to compare the information bit-by-bit. Obviously, this method is very time consuming and would not be able to keep up with the drift rate between the two databases. Thus, in the amount of time it took to review the databases, additional changes would have occurred and the review would have to restart before it was finished. Another possible method of synchronizing is for one business to send all of their information to the other business to ensure that the information is identical. The problem with this approach is that, due to the massive size of the information, it is extremely costly and time consuming. Additionally, if the companies wish to ensure each day, or multiple times each day, that the data has remained identical, their costs would substantially increase. For example, an international banking institution might have millions, or even possibly billions, of transaction records. Even worse, each transaction record could be composed of thousands of bits, thus dramatically increasing the amount of digital information that must be transferred, far beyond just the number of records. Therefore, this approach proves to be too costly for practical business applications. In fact, even though synchronization protocols might be continuously running to keep databases synchronized, because of system errors, two databases can become out of synchronization. Generally, it is very difficult to detect all of the places where the databases differ.

In more complex business models, each database might be an equivalent database rather than an identical copy of another database. This increases the complexity of determining which database has the correct information. Thus, it might require that even more digital information be exchanged or information be transformed into logically equivalent information between entities to ensure that the databases are equivalent in any necessary aspects. Therefore, businesses desire that a synchronization method be flexible enough to handle equivalent and identical databases on disparate platforms while, at the same time, be cost and time efficient such that frequent synchronizations are feasible. Businesses typically already have synchronization methods in place, and, thus, a means to facilitate these existing methods in order to obtain additional flexibility and error detection is highly desirable. This would allow a company to ensure that its information is correct and that their business is operating with the most up-to-date information as possible. The efficiency and cost effectiveness of business data transactions can directly increase both customer satisfaction and profitability.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates generally to data synchronization, and more particularly to systems and methods for determining discrepancies between data sets. Data hierarchies are leveraged to provide a systematic means to determine data differences between equivalent data. This allows disparate data storage systems to efficiently determine divergent data locations by utilizing, for example, data signatures representative of varying degrees of data granularity. Comparative analysis can then be performed between the databases by employing an iterative approach until the desired level of data granularity is obtained at which point sending details about records suspected to be mismatched becomes manageable. This allows, in one instance of the present invention, discrepant data to be determined without the transfer of large amounts of data and without requiring homogeneous data storage systems. Another instance of the present invention utilizes equivalent logical data views from non-identical data sets to determine data discrepancies. Yet another instance of the present invention determines discrepancies of a federated and/or integrated data system by employing reversible data statistical signatures, providing a simplistic transfer protocol and sheltering each data system from the other's complexities. Thus, the present invention provides a substantial improvement in data discrepancy determination, both in speed and cost.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a hierarchical drift detection system in accordance with an aspect of the present invention.

FIG. 2 is another block diagram of a hierarchical drift detection system in accordance with an aspect of the present invention.

FIG. 3 is yet another block diagram of a hierarchical drift detection system in accordance with an aspect of the present invention.

FIG. 4 is still yet another block diagram of a hierarchical drift detection system in accordance with an aspect of the present invention.

FIG. 5 is an illustration of partitioning a hierarchical data structure in accordance with an aspect of the present invention.

FIG. 6 is an illustration of an equivalent database in accordance with an aspect of the present invention.

FIG. 7 is an illustration of disparate platforms in accordance with an aspect of the present invention.

FIG. 8 is an illustration of data structure isolation in accordance with an aspect of the present invention.

FIG. 9 is a flow diagram of a method of facilitating data discrepancy determination in accordance with an aspect of the present invention.

FIG. 10 is another flow diagram of a method of facilitating data discrepancy determination in accordance with an aspect of the present invention.

FIG. 11 is yet another flow diagram of a method of facilitating data discrepancy determination in accordance with an aspect of the present invention.

FIG. 12 illustrates an example operating environment in which the present invention can function.

FIG. 13 illustrates another example operating environment in which the present invention can function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Additionally, a component can also include a human element. For example, a human can take a digest of databases manually to a second organization and compare it manually and/or a human can burn a CD with the data that is sent via courier to second organization. Though in-efficient, a human can also be the one creating the digest.

Enterprise software requires disparate entities to share information and collaboratively update the data. There are a number of available algorithms known to accomplish this, but for a variety of reasons such as strong assumptions required by an algorithm not holding up, errors in the implementation, and/or updates happening outside the implementation of the algorithms, the utilization of these algorithms results in copies of data maintained in two different places becoming or “drifting” out of synchronization. The present invention provides a way to locate these discrepancies as an ongoing process so that requisite cleanups can be done. In general, the systems and methods of the present invention are utilized to facilitate existing protocols that propagate and apply changes. However, instances of the present invention can also be utilized for detecting and fixing changes, though it is typically not as efficient as pro-actively propagating changes. One instance of the present invention employs two components, namely a partitioning component that partitions data into smaller chunks and a signature component that computes signatures for the smaller chunks. Another party then compares the signature of each chunk with signatures from their own chunks of data and identifies chunks whose signatures do not match with their own. For non-matching chunks, the chunks are then broken down into a lower level of granularity and re-signed and sent to the other party. The other party re-computes its corresponding chunk to determine which of the larger non-matching chunks do not match. The process is then repeated for smaller and smaller non-matching chunks until the specific non-matching records and/or data are found. Thus, the present invention can be employed to facilitate in locating discrepant data to allow requisite synchronization of the data by various data management entities. The present invention also facilitates to reduce the data set associated with a data mismatch between entities. The selection process is logarithmic, producing ‘n’ messages for ‘n’ elements in a data set. For example, if there are ‘d’ discrepancies, in the worst case, all of them can have an independent path from a master digest. So, it produces d*log(n) messages. In this case, all the data is erroneous, so, this produces n*log n messages. Thus, this protocol is useful when d is so small that d*log n is substantially smaller than n. This is superior to a linear process that requires that a complete data set be transmitted between entities, increasing transaction costs substantially.

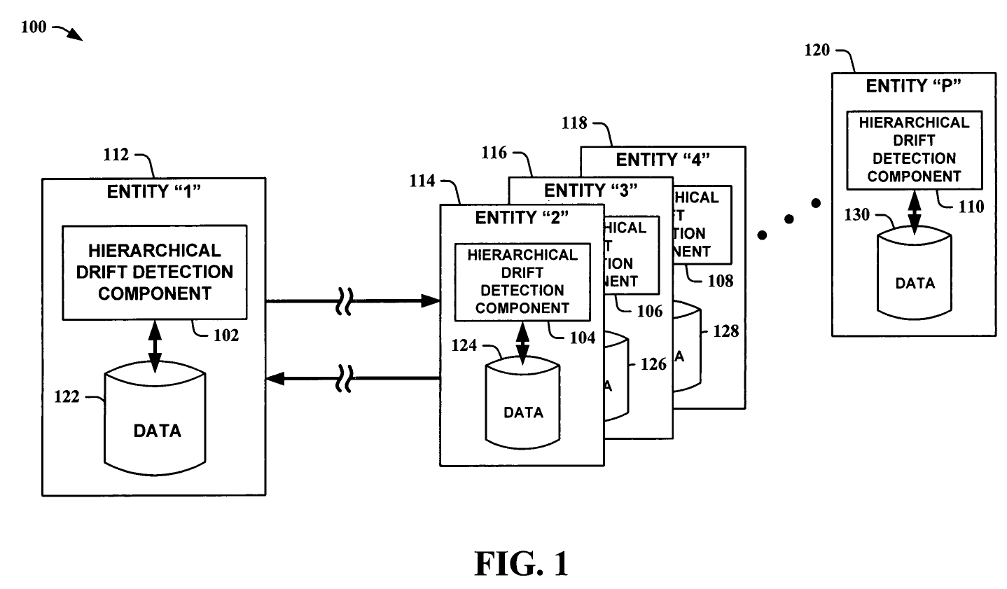

In FIG. 1, a block diagram of a hierarchical drift detection system 100 in accordance with an aspect of the present invention is shown. The hierarchical drift detection system 100 is comprised of a plurality of hierarchical drift detection components 102-110 associated with a plurality of data management entities “1-P” 112-120, where P represents an integer from one to infinity. Each data management entity “1-P” 112-120 manages a data set 122-130, respectively. In this instance of the present invention, the hierarchical drift detection system 100 is a distributed system with components residing locally with the corresponding data management entity. However, one skilled in the art can appreciate that not all of the data management entities “1-P” 112-120 are required to possess a local hierarchical drift detection component to fall within the scope of the present invention. Thus, a hierarchical drift detection component can reside externally to one or more data management entities. The communication means between the data management entities “1-P” 112-120 include, but are not limited to, global communication networks such as the Internet, radio communications, telephonic communications, satellite communications, and optical communications and the like. The communication means can also include printed media and digital media (such as CD ROMs, floppy disks, hard drives, flash drives, and the like) and the like. This allows information to be exchanged between entities via traditional physical shipping means and the like. One skilled in the art will appreciate that any communication means that enables information to be exchanged between entities is within the scope of the present invention.

The hierarchical drift detection component 102 of entity “1” 112 employs a digital signature technique to partitions associated with the structure of the associated data set 122. Partitioning is accomplished by domain specific algorithms. A ‘signature’ or digest is created for each individual partition. So, signatures are created post partitioning. However, the entire set <partition1-signature>, <partition2-signature> can be thought of as the signature of the whole data set and the partitioning algorithm to be just a part of the signature algorithm. This allows a condensed version of the data to be transmitted to the other data management entities. Likewise, the other hierarchical drift detection components 104-110 also employ digital signature techniques to their associated data sets 124-130 on equivalent data. If data management entity “1” 112 is considered the master, for example, it 112 can initiate a partitioning of its data set 122 based on a highest level of the data structure. This yields data partitions with the coarsest resolution of the data structure. A signature is then calculated for each coarse data partition by the hierarchical drift detection component 102, and a statistical signature is then utilized based on these individual data signatures to create a single signature representative of the coarse data partitions. The data management entity “1” 112 then transmits the statistical data signature to the other data management entities “2-P” 114-120. Each entity “2-P” 114-120 compares the statistical signature from data management entity “1” 112 to their own computed statistical signature of the equivalent level of coarse data partitions. If one of the entities “2-P” 114-120 finds a mismatch, it compares the signatures of the partitions to identify mismatched partitions. For each mismatched partition, it partitions at one level deeper and calculates signatures for this level of the data. The new signatures are then transmitted back to data management entity “1” 112. Data management entity “1” 112 then compares this new level of data signatures to its own signatures at that level. This iterative process continues until a criterion is reached such as, for example, a data subset is obtained that is small enough to be transmitted without substantial cost, an atomic data granularity level has been reached, a predetermined time limit has been reached, a predetermined granularity level has been reached, and/or a predetermined number of transmissions has occurred and the like.

The present invention can also utilize combined signatures such as utilizing a lower level signature and a higher level signature to form the signature that is transmitted between two entities. It can also incorporate techniques such that disparate data structures can be shielded (i.e., isolated) from another entity and non-identical data sets can also be synchronized through equivalent data sets formed by logical views. If two datasets are being dynamically updated while still detecting errors in a running system, a logical view can capture data as of event X. One skilled in the art will appreciate that there are multiple ways of marking event X, including synchronized time, Lamport's vector clock, etc. These aspects of the present invention are detailed infra.

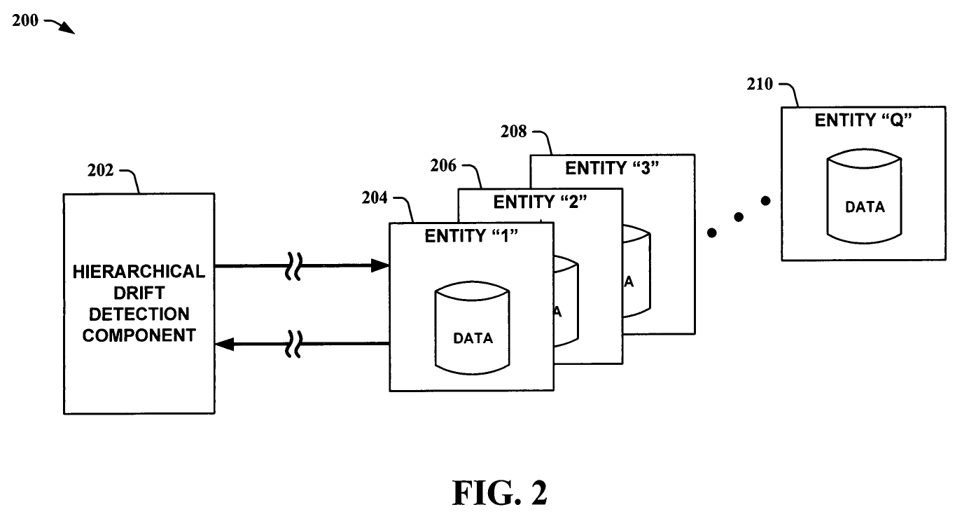

Referring to FIG. 2, another block diagram of a hierarchical drift detection system 200 in accordance with an aspect of the present invention is depicted. The drift detection system 200 is comprised of a hierarchical drift detection component 202 that interfaces with data management entities “1-Q” 204-210, where Q represents an integer from one to infinity. Each data management entity “1-Q” 204-210 has a data set associated with it. In this example of an integrated system, the hierarchical drift detection component 202 can reside external to the data management entities and/or reside in a single data management entity. One skilled in the art can appreciate that varying degrees of integration are still within the scope of the present invention. Thus, the hierarchical drift detection component 202 can reside on one, two, three, etc. different data management entities and still not reach a fully federated system with components associated with each data management entity.

In this instance of the present invention, the single hierarchical drift detection component 202 communicates with the data management entities “1-Q” 204-210 to determine if any data mismatches have occurred. It 202 asks each of the entities 204-210 for the signatures and combines their signatures into one master signature. It 202 then receives a master signature from another entity and identifies the sub-partitions where there are mismatches. At this point, it 202 has at least two options (1) still stay in loop, ask the sub-partition to provide a more detailed signature, and merge them together in a detailed signature or (2) ask the sub-partitions to talk directly to the corresponding sub-partition on the other side in order to detect errors at a finer level of granularity. Generally speaking, it 202 does not start by asking sub-components for mismatches, since sub-components typically only know their data and have not received information about the other side.

This is accomplished, in one example of the present invention, via iterative processing of signatures generated on data provided by the individual data management entities “1-Q” 204-210. The signatures are received by the hierarchical drift detection component 202 and analyzed against signatures received from other data management entities. In this manner, the hierarchical drift detection component 202 can direct a data synchronization evaluation by requesting data signatures at appropriate data structure levels. The data structure levels themselves can also be dictated via the hierarchical drift detection component 202.

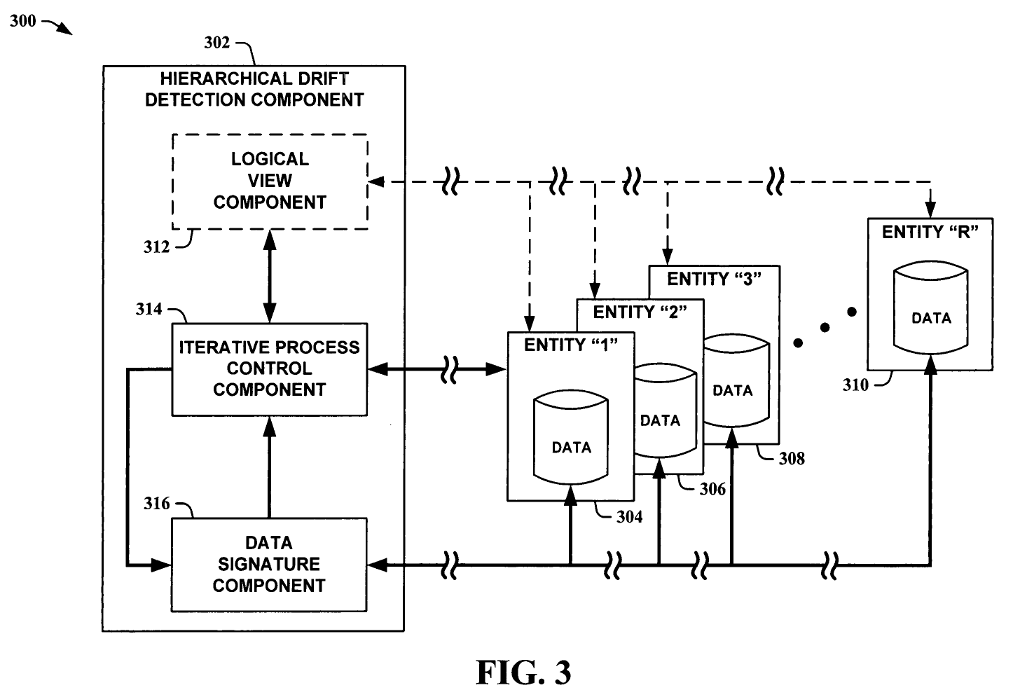

Turning to FIG. 3, yet another block diagram of a hierarchical drift detection system 300 in accordance with an aspect of the present invention is illustrated. The hierarchical drift detection system 300 is comprised of a hierarchical drift detection component 302 that interfaces with data management entities “1-R” 304-310. The hierarchical drift detection component 302 is comprised of an optional logical view component 312, an iterative process control component 314, and a data signature component 316. The hierarchical drift detection component 302 is representative, in this instance of the present invention, of both integrated and/or federated hierarchical drift detection systems. That is, the hierarchical drift detection component 302 can reside externally to the data management entities “1-R” 304-310 and/or can be duplicated within each data management entity “1-R” 304-310 and/or some functions can reside in some data management entities while other functions reside in other data management entities.

The optional logical view component 312 is utilized when disparate data structures are associated with the data management entities “1-R” 304-310. The logical view component 312 interfaces with the data management entities “1-R” 304-310 and the iterative process control component 314 to determine an appropriate logical view that can be employed by the hierarchical drift detection system 300. In this manner, the detection of data discrepancies is independent of the structure of the data sets. This affords the present invention great flexibility in its deployment, substantially surpassing traditional data synchronization systems. Once a logical data view has been selected, if necessary, the iterative process control component 314 initiates the data signature component 316 to determine data signatures for a data set. The data signature is then passed to the iterative process control component which then transmits the data signature to an appropriate data management entity. A response from the data management entity is evaluated by the iterative process control component 314 to determine if any mismatched data has been detected. If mismatches have occurred, it 314 initiates the data signature component 316 to determine data signatures for one lower level of the data that has been partitioned according to its structure. This process continues until the iterative process control component 314 has determined that a stop criterion has been met as elaborated supra.

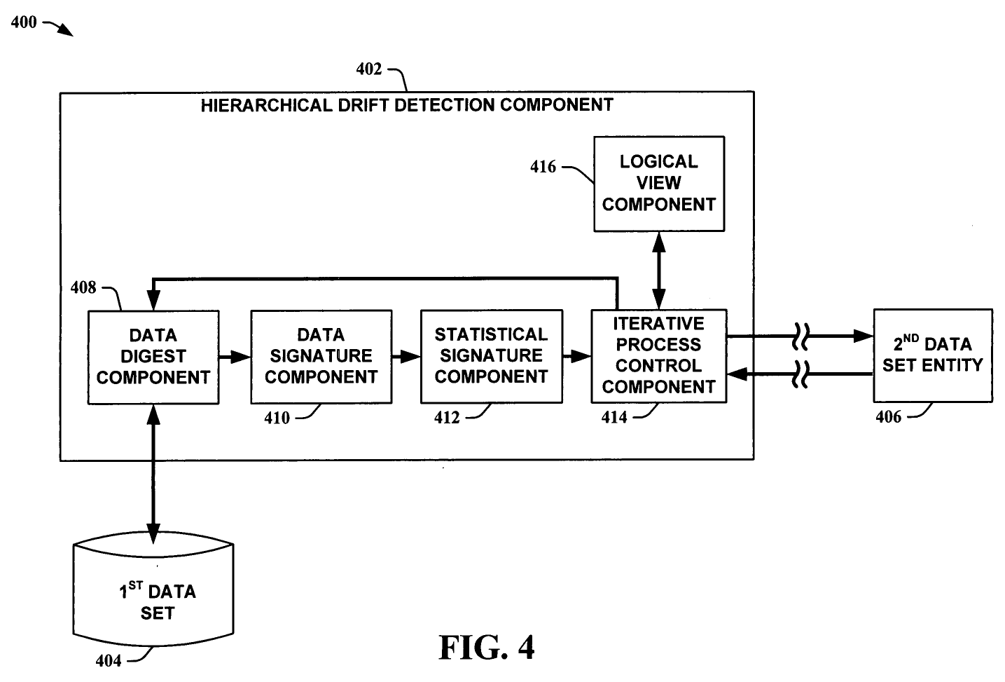

Moving on to FIG. 4, still yet another block diagram of a hierarchical drift detection system 400 in accordance with an aspect of the present invention is shown. The hierarchical drift detection system 400 is comprised of a hierarchical drift detection component 402 that interfaces with a first data set 404 and a data management entity with a second data set 406. The hierarchical drift detection component 402 is comprised of a data digest component 408, a data signature component 410, a statistical signature component 412, an iterative process control component 414, and a logical view component 416. The iterative process control component 414 controls the cyclic nature of the system 400 and transmits/receives condensed data to/from the second data set 406. It 414 also interfaces with the logical view component 416 when necessary to determine an appropriate logical data view for disparate data structures. The iterative process control component 414 also utilizes stopping criteria as detailed supra to halt the process. It 414 also interfaces with the data digest component 408 to initiate cycles of the process and to transmit a desired level of partitioning. The data digest component 408 partitions the first data set 404 initially by the coarsest data available (i.e., highest data structure level). During subsequent iterations, lower levels are partitioned as determined by the iterative process control component 414. The data digest component 408 “digests” or condenses the data partitions from the first data set 404. The data signature component 410 then receives the data digests and determines a data signature for each of the data digests. The statistical signature component 412 then receives the data signatures and computes a statistical signature based on the data signatures. The iterative process control component 414 then receives and transmits the statistical signature to the second data set 406 for comparison. This allows the present invention to efficiently send representations of the data at a much lower cost.

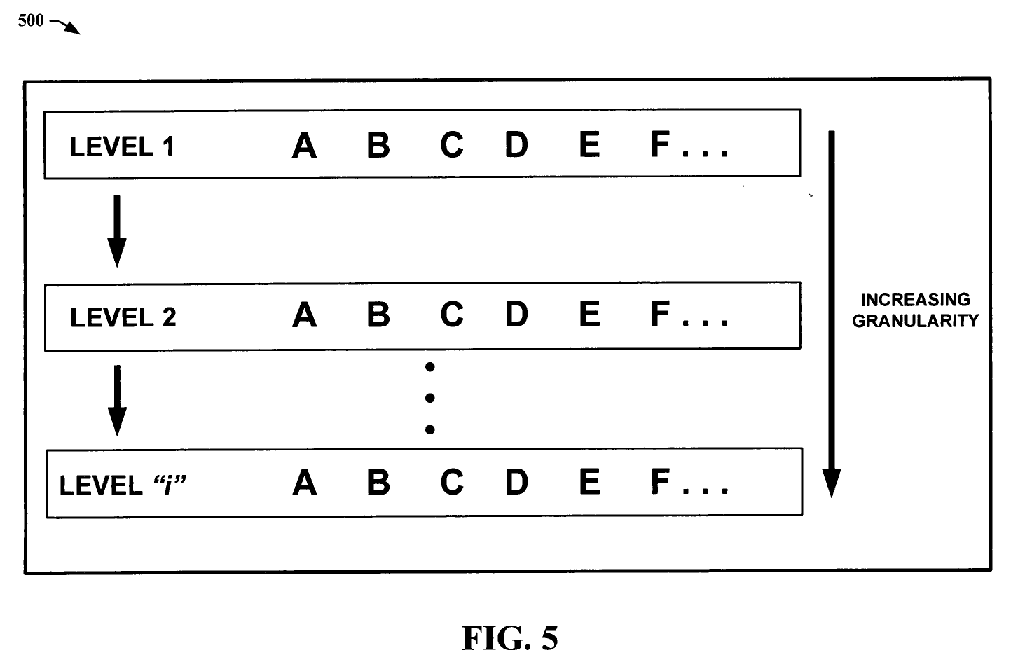

The supra systems of the present invention facilitate in eliminating the widespread problems surrounding data drifting. The present invention accomplishes this in a generic and expedited manner. The algorithm employed by instances of the present invention generally utilizes two components. The first component provides a way to partition data into smaller chunks. This partitioning scheme allows multiple levels of partitioning. For example, suppose the data being maintained is about customers as shown in the illustration 500 in FIG. 5. The data can be partitioned based on the first character of the name of customer. This returns the same number of chunks as the number of letters in the alphabet. Partitioning can then be accomplished utilizing the first two characters of a customer name, and it will return n² chunks. In general, nⁱ chunks are then utilized, where i is the level number. However, typically, substantially fewer numbers of chunks occur because errors generally reside at lower levels of a system. Thus, for example, if signatures for all customers whose name starts with an ‘A’ matched perfectly, finer chunks are not produced for any of the ‘A’ customers, yielding less than n² chunks. The second component provides a way to compute a digest of a ‘chunk’ of data. This digest method should be fast, and the digest itself should be small. Examples of such digest methods include, but are not limited to, standard cyclical redundancy checks (CRC), digital signatures, and domain specific statistical signatures (e.g., ‘just the number of elements’ in that chunk, minimum, maximum, last updated date time, etc.—it can even be a combination of other signatures) and the like.

The two components are then utilized with the algorithm as follows. First, the data is broken up into chunks at a highest level (i.e., level 1), producing the coarsest chunks. Then the digest is computed for each chunk. Typically, the signature of a chunk is a tuple where the first element has the information required to identify the chunk and the second element is the ‘digest’ of the chunk. In the example supra, the ‘prefix’ in the name string utilized for grouping is sufficient to identify the chunk and number of customers in that chunk is the digest. The Statistical Signature of the data set is computed by the set of signatures of the chunks of data. The complete statistical signature of data is sent to another entity. The other entity then computes the Statistical Signature in an equivalent fashion. It compares the signature of each chunk and identifies the chunks whose signatures do not match. For each of these mismatched chunks, it partitions data one level deeper (e.g. utilizing two characters for a customer name), computes the signatures for the partitions, and sends the signatures back to the original entity. The signature of a data set is now more detailed for the mismatched chunks. Depending on the instance of the present invention, the present invention can mix these details with other high level signatures and/or send a special message with ‘mismatched’ chunks only. Entities continue sending data back and forth, successively refining it until the granularity comes to the level of a single row and/or the chunk becomes so small that the complete chunk can be sent. A comparison at this point identifies the rows that are missing on either side and/or have conflicting data. Conflict resolution can be done with standard resolution methodologies, for example, such as defining one of the sources as the master and winning the conflict every time, random decision making, and/or manual intervention and the like.

Additionally, other instances of the present invention utilize a structure with the signatures to further facilitate locating data discrepancies. For example, groups can be employed that represent a top half and/or a bottom half and the like. This allows a comparing entity to utilize prior knowledge to more quickly discern where the mismatched data is located. One skilled in the art can appreciate that prior knowledge and/or probabilistic data error likelihood information can be employed to converge the iterative process more quickly. Multiple replies can also be given by an entity to facilitate the iterative process. Instances of the present invention also allow the comparing entity to ascertain which data segments and what levels are necessary to retransmit back to the originating entity. It is also not necessary to start with the coarsest data. For example, if during a first run it is discovered that frequent mismatches are found in most of the level 1 chunks, the protocol can start directly at level 2. Since signatures are utilized, two different data sets can produce a substantially similar signature, and, all the problems might not be detected. The width of the signature can be controlled, in one instance of the present invention, to control the probability that some conflict might be missed. Furthermore, drift detection can be repeated to enhance detection of errors in the data. Thus, in one instance of the present invention, different signature algorithms can be employed in different ‘runs’ to reduce the probability that a conflict might be missed.

The costs associated with employing the present invention to detect data discrepancies include the cost of computing the signatures by an entity, the cost of exchanging the signature between entities, and the cost of exchanging the data between entities. Cost can also be a function of the error rate. If an error rate is substantially high, it is more cost efficient to send the data. If the error rate is substantially low, it is more efficient to utilize the present invention to determine any data discrepancies. Additionally, instances of the present allow a user to determine at what level of granularity they wish to pursue to find mismatched data. Generally speaking, this also indicates a cost level that the user is willing to accept.

There are many parameters for this algorithm that can be fine tuned based on application and/or user preferences and the like. These include, but are not limited to, at what point is it better to send a complete dump of a ‘set suspected to be out of sync’ rather than keep sending a digest, whether the send/receive of mismatches are separated from the send/receive of ‘signatures,’ how often and with what method to compute the signatures, and how good is the signature in catching the kind of errors expected and the like. Thus, parameters such as these can be utilized to extract maximum efficiency from a data synchronization scheme that employs the present invention.

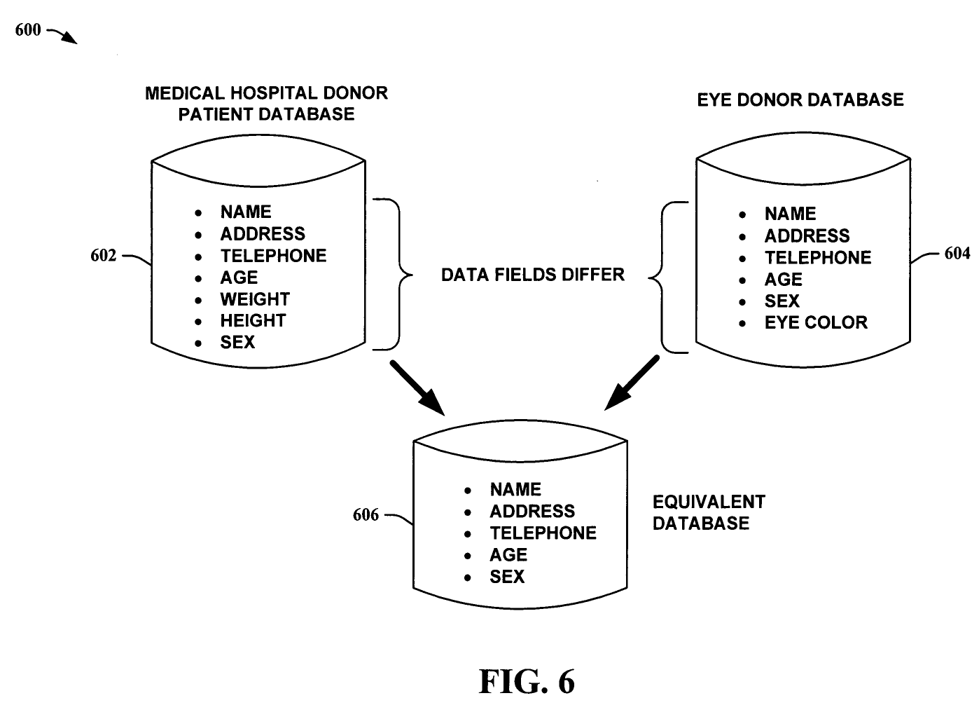

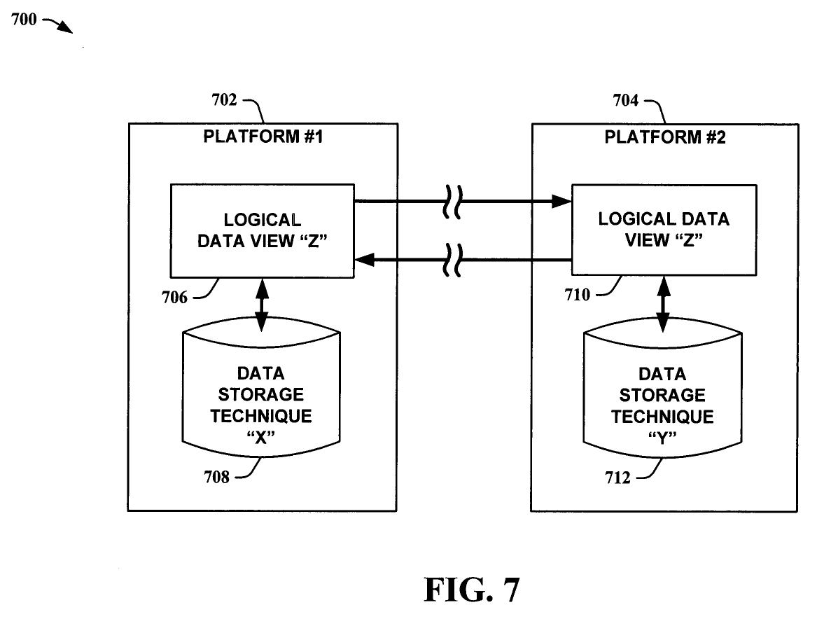

The present invention also facilitates in synchronizing disparate databases as shown in the illustration 600 in FIG. 6. In this illustration 600, a patient database 602 and an eye donor database 604 have differing data fields. Instances of the present invention can resolve this conflict such that an equivalent database 606 is utilized for data discrepancy determination. This allows disparate data sets to be checked for mismatched data on only those fields that are of mutual concern. FIG. 7 provides an illustration 700 of disparate platforms 702, 704 in accordance with an aspect of the present invention. The first platform 702 utilizes a data storage technique “X” for storing its data set 708. The second platform 704 utilizes a data storage technique “Y” for storing its data set 712. Although the two storage techniques make direct comparison of the data difficult, instances of the present invention provide a logical view component that can determine, in this example, a logical data view “Z” 706, 710 that can be employed on both platforms 702, 704. This enables data to be checked for discrepancies without requiring like data storage techniques.

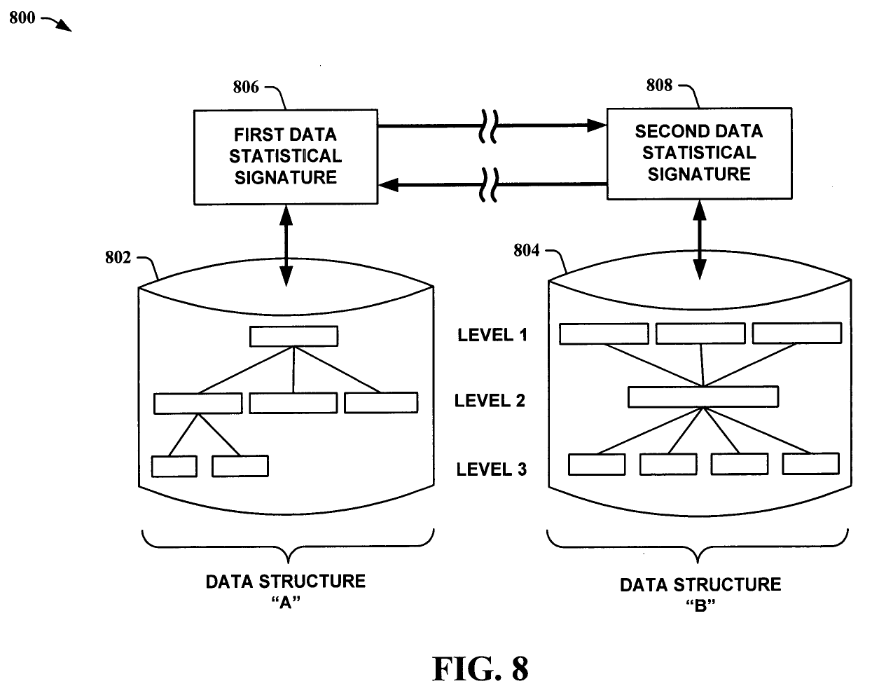

Turning to FIG. 8, an illustration 800 of data structure isolation in accordance with an aspect of the present invention is depicted. In this example, instances of the present invention can be utilized to shield data structures from other entities. A first data set 802 utilizes a hierarchical data structure “A,” while a second data set 804 utilizes a hierarchical data structure “B.” The levels of each data structure differ significantly, making direct comparisons for data discrepancy detection very difficult. Thus, for example, comparing data signatures for partitions of level 1 will yield poor results. However, if a statistical signature is utilized for each data set, a first data statistical signature 806 can be compared to a second statistical signature 808 based on equivalent data. Additionally, even if, for example, data structure “A” includes a federated external system (e.g., a company that has subordinate companies and sibling companies that contain bits of data each), the first data statistical signature 806 will mask this structure from the second data set 804. Additionally, the statistical signatures allow reverse engineering of structure so that a mismatch indication can still be utilized to locate data even if it is reported via a statistical signature.

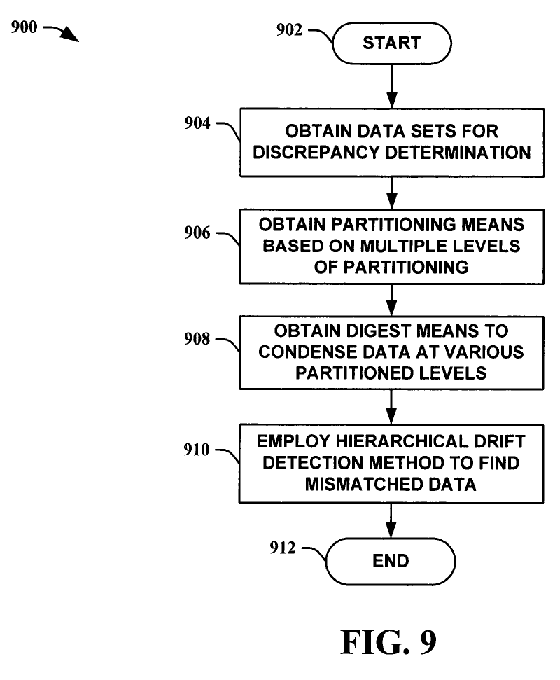

In view of the exemplary systems shown and described above, methodologies that may be implemented in accordance with the present invention will be better appreciated with reference to the flow charts of FIGS. 9-11. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the present invention.

In FIG. 9, a flow diagram of a method 900 of facilitating data discrepancy determination in accordance with an aspect of the present invention is shown. The method 900 starts 902 by obtaining data sets for discrepancy determination 904. The present invention is not limited by the number of data sets that can be utilized for comparing data. A partitioning means based on multiple levels of partitioning is then obtained 906. The partitioning means exploits the hierarchy of a data set to allow varying levels of granularity of the partitioned data. A digest means is then obtained to condense data at the various levels of partitioning 908. Generally, the digest means is a fast process that produces small digests. Examples of a digest means include, but are not limited to, standard CRCs, digital signatures, and domain specific statistical signatures and the like. The domain specific statistical signatures can also include a combination of other signatures. A hierarchical drift detection method is then utilized to locate mismatched data 910, ending the flow 912. The hierarchical drift detection method employs the partitioning means and the digest means to isolate the mismatched data at a sufficient granular level in the data set structures. The method can also halt the process based upon a user and/or system set criterion such as, for example, a data subset is obtained that is small enough to be transmitted without substantial cost, an atomic data granularity level has been reached, a predetermined time limit has been reached, a predetermined granularity level has been reached, and/or a predetermined number of transmissions has occurred and the like. The hierarchical drift detection method is further elaborated infra.

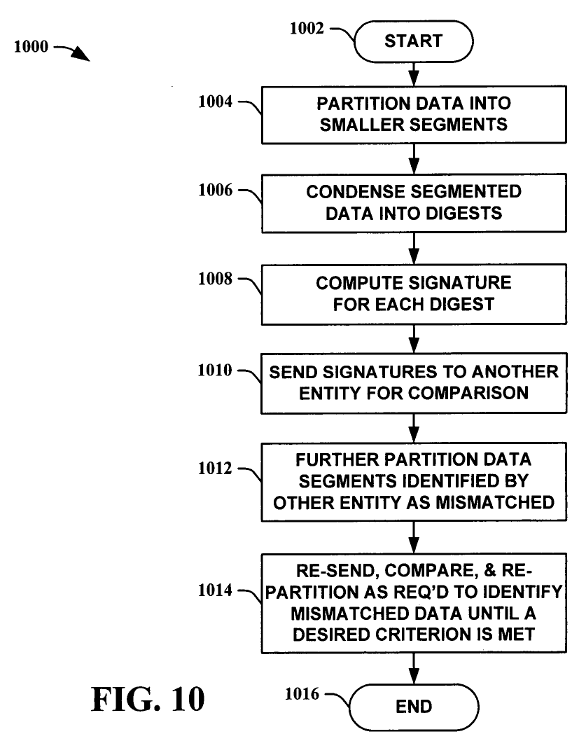

Referring to FIG. 10, another flow diagram of a method 1000 of facilitating data discrepancy determination in accordance with an aspect of the present invention is depicted. The method 1000 represents a hierarchical drift detection method for an instance of the present invention. The method 1000 starts 1002 by partitioning data from a data set into smaller segments based upon levels of a data structure 1004. The data segments are then condensed into digests 1006. The digests represent the original data without utilizing the same amount of bit information. A signature is then computed for each digested segment 1008. The signatures are then transmitted to another entity for comparison of like data 1010. The signatures for the digests can also include a statistical signature that incorporates one or more of the digest signatures. By transmitting a statistical signature instead of a digest signature, a smaller, and thus faster, transfer of information can occur. Utilizing a statistical signature also affords some reverse engineering ability for employing the information with disparate data structures. One skilled in the art will appreciate that the present invention can employ a combination of various signatures including, but not limited to, digest signatures and statistical signatures, mismatched data signatures and statistical signatures, and lower level and higher level digest signatures from a data structure and the like. Data segments associated with signatures identified by the other entity as mismatched are further partitioned and processed 1012. The further partitioned segments are then digested and signatures are created for each mismatched digest. This information is then transmitted back to the originating entity and the process continues until a desired criterion is met 1014, ending the flow 1016. The desired criterion can be a system criterion and/or a user criterion and includes, but is not limited to, the criteria elaborated on supra.

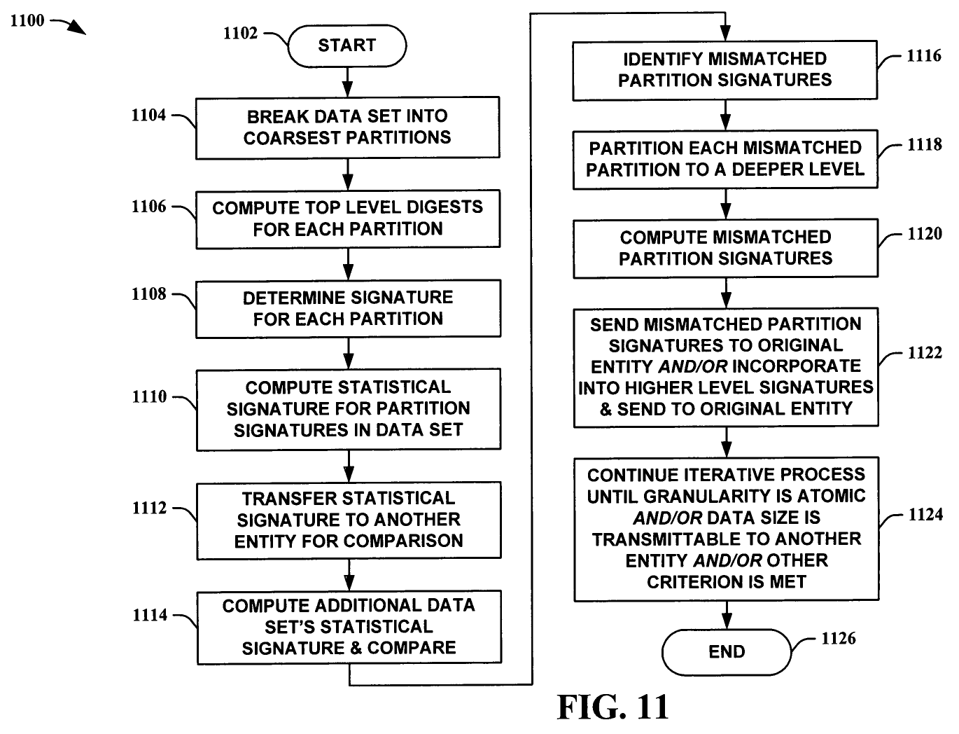

Turning to FIG. 11, yet another flow diagram of a method 1100 of facilitating search data manipulation in accordance with an aspect of the present invention is illustrated. The method 1100 starts 1102 by breaking the data set into its coarsest partitions based upon levels of a data structure's hierarchy 1104. Generally, the coarsest level is the first level of the data structure. Digests are then computed for the top level data partitions 1106. Signatures for the digests are then determined for each partition 1108. A statistical signature representing the digest signatures is then computed for the partitions 1110. The statistical signature is then transferred to another entity for comparison 1112. The entity can be a data management entity and the like. The other entity then computes a statistical signature for like data represented by the received statistical signature and compares the two signatures 1114. Mismatched partition signatures are then identified when a statistical signature is mismatched 1116. Each mismatched partition is then partitioned to a deeper level to facilitate in locating the mismatched data 1118. New mismatched data signatures are then computed for the new level partition signatures 1120. The mismatched data signatures are then transmitted back to the originating entity and/or the mismatched data signatures are incorporated into higher level signatures and then transmitted to back to the originating entity 1122. Thus, the present invention provides the flexibility to combine various signatures to further facilitate in locating mismatched data. This iterative process is continued until the granularity of the data is atomic (i.e., data cannot be reduced/segmented into a smaller segment), the data size is transmittable to another entity, and/or a desired criterion is met such as those described supra 1124, ending the flow 1126.

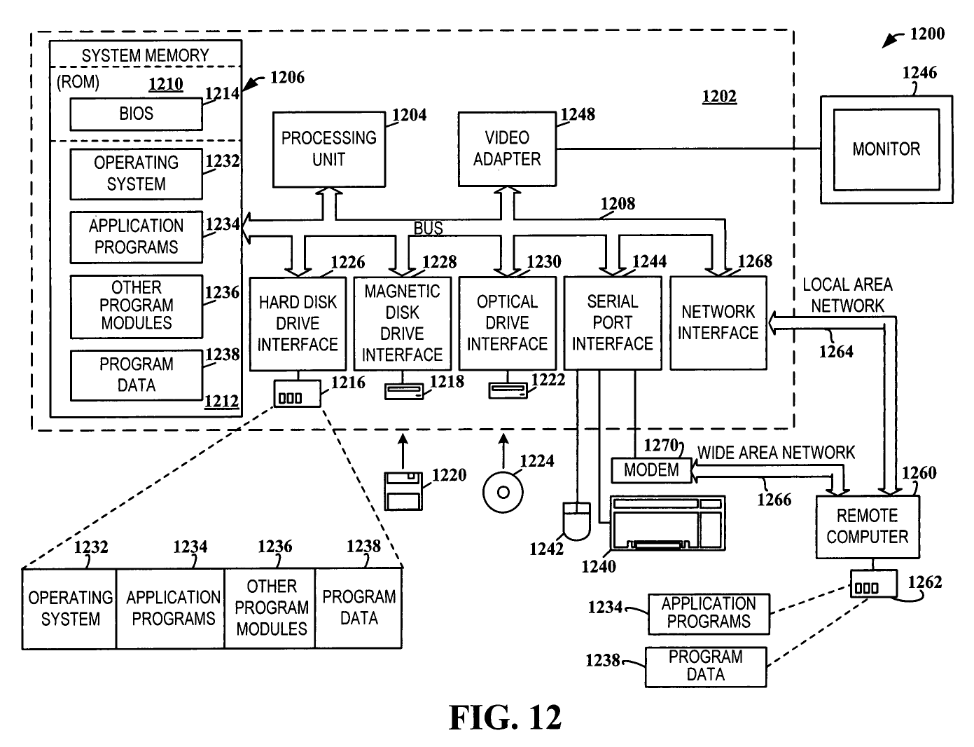

In order to provide additional context for implementing various aspects of the present invention, FIG. 12 and the following discussion is intended to provide a brief, general description of a suitable computing environment 1200 in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 12, an exemplary system environment 1200 for implementing the various aspects of the invention includes a conventional computer 1202, including a processing unit 1204, a system memory 1206, and a system bus 1208 that couples various system components, including the system memory, to the processing unit 1204. The processing unit 1204 may be any commercially available or proprietary processor. In addition, the processing unit may be implemented as multi-processor formed of more than one processor, such as may be connected in parallel.

The system bus 1208 may be any of several types of bus structure including a memory bus or memory controller, a peripheral bus, and a local bus using any of a variety of conventional bus architectures such as PCI, VESA, Microchannel, ISA, and EISA, to name a few. The system memory 1206 includes read only memory (ROM) 1210 and random access memory (RAM) 1212. A basic input/output system (BIOS) 1214, containing the basic routines that help to transfer information between elements within the computer 1202, such as during start-up, is stored in ROM 1210.

The computer 1202 also may include, for example, a hard disk drive 1216, a magnetic disk drive 1218, e.g., to read from or write to a removable disk 1220, and an optical disk drive 1222, e.g., for reading from or writing to a CD-ROM disk 1224 or other optical media. The hard disk drive 1216, magnetic disk drive 1218, and optical disk drive 1222 are connected to the system bus 1208 by a hard disk drive interface 1226, a magnetic disk drive interface 1228, and an optical drive interface 1230, respectively. The drives 1216-1222 and their associated computer-readable media provide nonvolatile storage of data, data structures, computer-executable instructions, etc. for the computer 1202. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 1200, and further that any such media may contain computer-executable instructions for performing the methods of the present invention.

A number of program modules may be stored in the drives 1216-1222 and RAM 1212, including an operating system 1232, one or more application programs 1234, other program modules 1236, and program data 1238. The operating system 1232 may be any suitable operating system or combination of operating systems. By way of example, the application programs 1234 and program modules 1236 can include a data discrepancy detection scheme in accordance with an aspect of the present invention.

A user can enter commands and information into the computer 1202 through one or more user input devices, such as a keyboard 1240 and a pointing device (e.g., a mouse 1242). Other input devices (not shown) may include a microphone, a joystick, a game pad, a satellite dish, wireless remote, a scanner, or the like. These and other input devices are often connected to the processing unit 1204 through a serial port interface 1244 that is coupled to the system bus 1208, but may be connected by other interfaces, such as a parallel port, a game port or a universal serial bus (USB). A monitor 1246 or other type of display device is also connected to the system bus 1208 via an interface, such as a video adapter 1248. In addition to the monitor 1246, the computer 1202 may include other peripheral output devices (not shown), such as speakers, printers, etc.

It is to be appreciated that the computer 1202 can operate in a networked environment using logical connections to one or more remote computers 1260. The remote computer 1260 may be a workstation, a server computer, a router, a peer device or other common network node, and typically includes many or all of the elements described relative to the computer 1202, although for purposes of brevity, only a memory storage device 1262 is illustrated in FIG. 12. The logical connections depicted in FIG. 12 can include a local area network (LAN) 1264 and a wide area network (WAN) 1266. Such networking environments are commonplace in offices, enterprise-wide computer networks, intranets and the Internet.

When used in a LAN networking environment, for example, the computer 1202 is connected to the local network 1264 through a network interface or adapter 1268. When used in a WAN networking environment, the computer 1202 typically includes a modem (e.g., telephone, DSL, cable, etc.) 1270, or is connected to a communications server on the LAN, or has other means for establishing communications over the WAN 1266, such as the Internet. The modem 1270, which can be internal or external relative to the computer 1202, is connected to the system bus 1208 via the serial port interface 1244. In a networked environment, program modules (including application programs 1234) and/or program data 1238 can be stored in the remote memory storage device 1262. It will be appreciated that the network connections shown are exemplary and other means (e.g., wired or wireless) of establishing a communications link between the computers 1202 and 1260 can be used when carrying out an aspect of the present invention.

In accordance with the practices of persons skilled in the art of computer programming, the present invention has been described with reference to acts and symbolic representations of operations that are performed by a computer, such as the computer 1202 or remote computer 1260, unless otherwise indicated. Such acts and operations are sometimes referred to as being computer-executed. It will be appreciated that the acts and symbolically represented operations include the manipulation by the processing unit 1204 of electrical signals representing data bits which causes a resulting transformation or reduction of the electrical signal representation, and the maintenance of data bits at memory locations in the memory system (including the system memory 1206, hard drive 1216, floppy disks 1220, CD-ROM 1224, and remote memory 1262) to thereby reconfigure or otherwise alter the computer system's operation, as well as other processing of signals. The memory locations where such data bits are maintained are physical locations that have particular electrical, magnetic, or optical properties corresponding to the data bits.

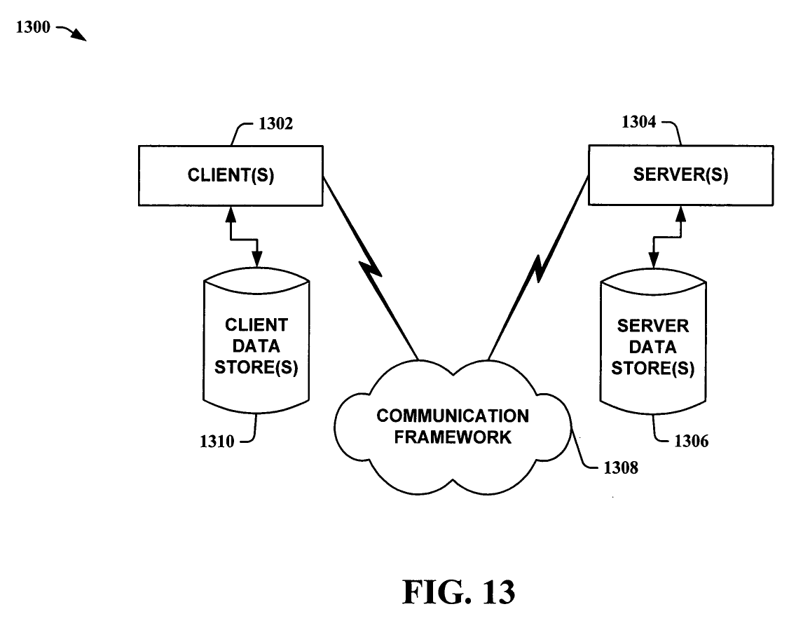

FIG. 13 is another block diagram of a sample computing environment 1300 with which the present invention can interact. The system 1300 further illustrates a system that includes one or more client(s) 1302. The client(s) 1302 can be hardware and/or software (e.g., threads, processes, computing devices). The system 1300 also includes one or more server(s) 1304. The server(s) 1304 can also be hardware and/or software (e.g., threads, processes, computing devices). One possible communication between a client 1302 and a server 1304 may be in the form of a data packet adapted to be transmitted between two or more computer processes. The system 1300 includes a communication framework 1308 that can be employed to facilitate communications between the client(s) 1302 and the server(s) 1304. The client(s) 1302 are connected to one or more client data store(s) 1310 that can be employed to store information local to the client(s) 1302. Similarly, the server(s) 1304 are connected to one or more server data store(s) 1306 that can be employed to store information local to the server(s) 1304.

In one instance of the present invention, a data packet transmitted between two or more computer components that facilitates data discrepancy determination is comprised of, at least in part, information relating to a data discrepancy determination system that utilizes, at least in part, at least one data signature representative of at least one data partition based, at least in part, on a hierarchical structure of a data set and utilized in an iterative process to isolate mismatched data.

It is to be appreciated that the systems and/or methods of the present invention can be utilized in data discrepancy detection facilitating computer components and non-computer related components alike. Further, those skilled in the art will recognize that the systems and/or methods of the present invention are employable in a vast array of electronic related technologies, including, but not limited to, computers, servers and/or handheld electronic devices, and the like.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates data discrepancy determination, comprising:
a partitioning component that utilizes a hierarchical structure of a data set to partition data at various levels of the data structure;
a digest component that condenses at least one data partition provided by the partitioning component;
a signature component that determines at least one signature of at least one data partition digested by the digest component; and
a comparison component that compares a data digest signature with at least one other data digest signature to ascertain if mismatched data exists; the other data digest signature representative of data that a user desires to be equivalent to data associated with the data digest signature.

2. The system of claim 1 further comprising:
an interface component that transfers data signatures between a plurality of data entities to facilitate comparison of the data signatures.

3. The system of claim 1 further comprising:
a statistical signature component that calculates a statistical signature utilizing the data digest signatures provided by the signature component; the statistical signature representative of a plurality of data digests without a dependency on the data's hierarchical structure.

4. The system of claim 3 further comprising:
a regression component that utilizes the statistical signature to determine data signatures for data partitions of at least one hierarchical data structure to facilitate in isolating mismatched data.

5. The system of claim 1 further comprising:
an iteration component that continually converges the data discrepancy determination until at least one selected from the group consisting of a lowest mismatched data structure level is obtained and a manageable mismatched data size is obtained.

6. The system of claim 5, the manageable mismatched data size comprising a data size that can be transferred between data entities without substantial costs.

7. The system of claim 1 further comprising:
a signature compilation component that utilizes a lower level mismatched data partition signature combined with a higher level data partition signature to create a compiled signature for utilization by the comparison component.

8. The system of claim 1 comprising at least one selected from the group consisting of a federated system and an integrated system.

9. The system of claim 1 further comprising:
a logical view component that establishes a logical data view for a plurality of disparate data sets to enable data discrepancy determination of equivocal data.

10. A method for facilitating data discrepancy determination, comprising:
partitioning data into chunks and assigning signatures to the respective chunks;
determining discrepancy in a subset of the chunks via a signature comparison;
further partitioning the chunk subset and assigning new signatures to the partitioned chunk subsets; and
repeating the discrepancy determination, partitioning, and assignment of new signatures until convergence upon specific non-matching records and/or data is achieved.

11. The method of claim 10, wherein the method is applied between a plurality of entities.

12. The method of claim 10, further comprising:
reversing a data signature to facilitate in locating mismatched data for a given federated data structure.

13. The method of claim 10, wherein at least two disparate entities successively perform the determination, partitioning, and assignment of new signatures.

14. The method of claim 13, wherein the entities are maintaining databases.

15. The method of claim 13, wherein the collection of data for at least one entity is different.

16. The method of claim 13, wherein the collection of data for at least one entity is equivalent but not identical.

17. The method of claim 10, wherein each new signature has a first element that identifies a respective chunk and a second element is a digest of the respective chunk.

18. The method of claim 17, wherein the digest is a cyclical redundancy check (CRC).

19. The method of claim 17, wherein the digest is a digital signature.

20. The method of claim 17, wherein the digest is a domain specific digital signature.

21. The method of claim 20, the signature is comprised of a signature that incorporates at least one lower level data chunk signature with at least one higher level data chunk signature.

22. The method of claim 10, further comprising:
correcting the non-matching records and/or data via conflict resolution.

23. The method of claim 22, wherein the conflict resolution is based on random decision.

24. The method of claim 22, wherein the conflict resolution is based on manual intervention.

25. The method of claim 22, wherein the conflict resolution utilizes a repair function that handles data that is not identical.

26. A system that facilitates data discrepancy determination, comprising:
means for partitioning a data set at various levels of a hierarchical data structure;
means for digesting at least one partition of a data set;
means for determining at least one data signature of at least one digested data partition; and
means for comparing a data digest signature with at least one other data digest signature to ascertain if mismatched data exists, the other data digest signature representative of data that a user desires to be equivalent to data associated with the data digest signature.

27. A data packet, transmitted between two or more computer components, that facilitates data discrepancy determination, the data packet comprising, at least in part, information relating to a data discrepancy determination system that utilizes, at least in part, at least one data signature representative of at least one data partition based, at least in part, on a hierarchical structure of a data set and utilized in an iterative process to isolate mismatched data.

28. A computer readable medium having stored thereon computer executable components of the system of claim 1.

29. A device employing the method of claim 10 comprising at least one selected from the group consisting of a computer, a server, and a handheld electronic device.

30. A device employing the system of claim 1 comprising at least one selected from the group consisting of a computer, a server, and a handheld electronic device.
